(19) United States
(12) Patent Application Publication
(10) Pub. No.: US 2008/0008379 A1
(43) Pub. Date: Jan. 10, 2008

(54) System and method for real-time determination of the orientation of an envelope

(75) Inventors: Richard S. Andel, Binghamton, NY (US); Rosemary D. Paradis, Vestal, NY (US); Kenei Suntarat, Endicott, NY (US); Dennis A. Tillotson, McDonough, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Lockheed Martin Corporation

(21) Appl. No.: 11/482,561

(22) Filed: Jul. 7, 2006

(51) Int. Cl. G06K 9/00; G06K 9/46; G06K 9/64; G06K 9/66

(52) U.S. Cl. 382/141; 382/190; 382/223

(57) ABSTRACT

A system for recognizing and identifying postal indicia on an envelope. This includes an image acquisition element that acquires a first image, representing a first side of the envelope, and a second image, representing a second side of the envelope. A feature extractor, for each of the first and second image, extracts a plurality of numerical feature values from each image as respective first and second feature vectors that represent the envelope. An orientation classification element classifies the envelope into one of a plurality of output classes representing a plurality of possible orientations according to the first and second feature vectors.

### BACKGROUND OF THE INVENTION

In mail handling application, a limited amount of time is available to make a decision about any one envelope that is input into the mail stream. For example, postal indicia (e.g., information on the envelope that is not address text) and at least a portion of the address text on an envelope or package must be scanned, located, and recognized in a period on the order of one hundred milliseconds to maintain the flow of mail through the system. These time constraints limit the available solutions for accurately classifying and verifying the various elements on an envelope.

The problem is further complicated by the fact that the orientation of the envelope in the mail handling system is not standard. While many systems maintain the envelope in a generally vertical (i.e., longest edge vertical) position, it is possible that the envelope will be rotated to a position opposite the standard orientation or flipped such that the back of the envelope is facing upwards. In these cases, the postal indicia to be identified may not be in the expected location.

### SUMMARY OF THE INVENTION

In accordance with one aspect of the present invention, a system is presented for recognizing and identifying the information on an envelope without specifically identifying any particular piece of indicia or text on the envelope. This includes an image acquisition element that acquires a first image, representing a first side of the envelope, and a second image, representing a second side of the envelope. A feature extractor, for each of the first and second image, extracts a plurality of numerical feature values from each image as respective first and second feature vectors that represent the envelope. An orientation classification element classifies the envelope into one of a plurality of output classes representing a plurality of possible orientations according to the first and second feature vectors.

In accordance with another aspect of the present invention, a computer program product, operative in a data processing system and stored on a computer readable medium, is provided that determines the orientation of an envelope. An image acquisition element obtains at least one binarized envelope image. A feature extraction element, for a given image of the envelope, divides the image into a plurality of regions, determines a value for each region representing the ratio of dark pixels within the region to the total area of the region, and combines the density values into a feature vector. A classification element classifies the envelope image into one of a plurality of output classes representing various orientations according to the feature vector.

In accordance with yet another aspect of the present invention, a method is provided for determining an associated orientation of an envelope in real-time. At least one envelope image is acquired. Each envelope image is divided into a plurality of regions. At least one numerical feature value is extracted from each of the plurality of regions associated with a given envelope image. The extracted numerical feature values from each of the plurality of regions associated with a given envelope image are combined into a single feature vector representing the envelope image. A set of three output values is determined from the feature vector representing each envelope image. A first output value represents the likelihood that the envelope image represents an arbitrary default orientation of the front of the envelope. A second output value represents the likelihood that the envelope image represents an orientation of the front of the envelope that is rotated one hundred eighty degrees from the default orientation. A third output value represents the likelihood that the envelope image represents the back of the envelope.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates an orientation recognition system in accordance with an aspect of the present invention;

FIG. 2 illustrates a graphical representation of an exemplary feature extraction process in accordance with an aspect of the present invention;

FIG. 3 illustrates an exemplary artificial neural network classifier;

FIG. 4 illustrates a methodology for determining the orientation of an envelope in accordance with an aspect of the present invention;

FIG. 5 illustrates an exemplary mail handling system incorporating an orientation recognition system in accordance with an aspect of the present invention;

FIG. 6 illustrates an exemplary image processing system for a mail handling system in accordance with an aspect of the present invention; and

FIG. 7 illustrates a computer system that can be employed to implement systems and methods described herein.

### DETAILED DESCRIPTION OF THE INVENTION

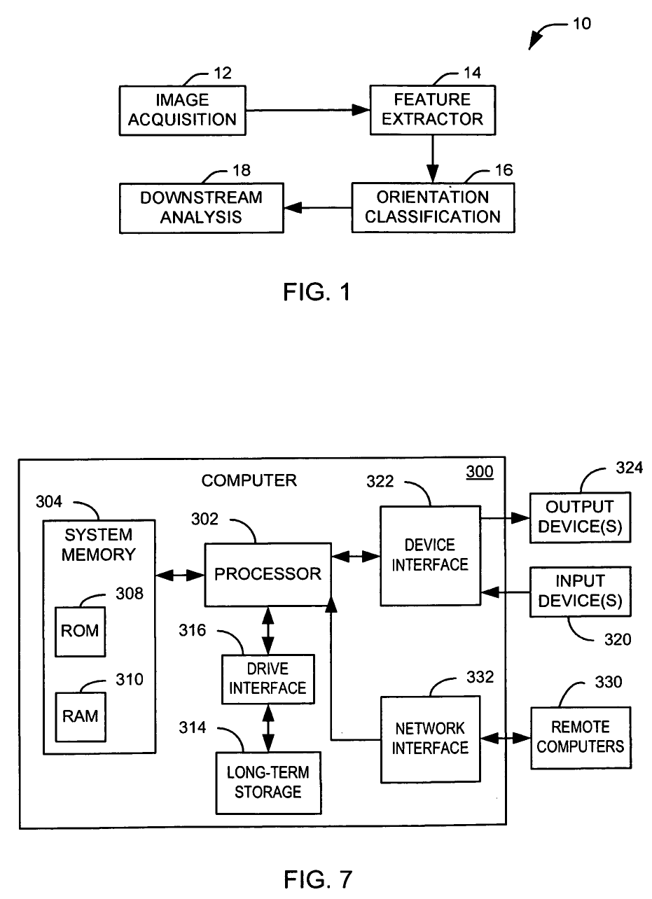

The present invention relates to systems and methods for efficient determination of the orientation of an envelope. FIG. 1 illustrates an orientation recognition system 10 that identifies the orientation and facing of an envelope in accordance with an aspect of the present invention. For ease of reference, the term “orientation” is utilized herein to encompass both the orientation and facing of the envelope. It will be appreciated that knowledge of the orientation of the envelope allows for simplification of future analysis of the envelope image (e.g., optical character recognition of all or a portion of the address, postage verification, postal indicia detection and recognition etc.). Further, once the envelope is oriented and faced, it is canceled and sprayed with an identification tag. In order to process the mail appropriately, the cancellation and the id tag need to be placed in the correct location on the envelope, requiring an accurate determination of the facing and orientation.

To this end, the illustrated system 10 is designed to determine the orientation of an envelope in an extremely short period of time, generally on the order of tens of milliseconds. During this time, the system extracts a plurality of numerical feature vectors from at least one image of the envelope and classifies the envelope image into one of a plurality of possible orientations. It is necessary that the orientation recognition system 10 operate with great efficiency to retain time and processing resources for the downstream analysis of the envelope that the orientation recognition system 10 is intended to facilitate.

One or more images of the envelope are acquired for analysis at an image acquisition element 12. For example, in one implementation, respective lead and trail cameras on either side of a conveyer belt associated with the mail sorting system are used to take an image of each side of the envelope, such that one image represents a front side of the envelope and the other image represents a back side of the envelope. It will be appreciated that these images can comprise grayscale and color images of various resolutions that can be binarized such that each pixel is represented by a single bit as “dark” or “white”.

In an exemplary implementation, envelopes are maintained in a vertical position (i.e., longest edge vertical) while they are on a conveyor belt within a mail handling system, but the orientation of the envelope is otherwise unknown. In this arrangement, the envelope can only assume one of four possible positions. Specifically, the envelope can be in a “normal” orientation, where the front of the envelope faces the lead camera and the address reads from the bottom of the envelope to the top, rotated one hundred eighty degrees, flipped to where the back of the envelope faces the lead camera, or both flipped to the back side and rotated one hundred eighty degrees.

Each envelope image is provided to a feature extractor 14 that extracts features from the isolated region of interest. The feature extractor 14 derives a vector of numerical measurements, referred to as feature variables, from the candidate image. Thus, the feature vector represents its associated envelope image in a modified format that attempts to represent various aspects of the original image.

The features used to generate the feature vector are selected both for their effectiveness in distinguishing among a plurality of possible orientations for the envelope and for their ability to be quickly extracted from the image sample, such that the extraction and classification processes can take place in real-time. In an exemplary embodiment, a given envelope image is divided into a plurality of regions, and the number of dark pixels in each region is counted. This value is then divided by the area of the region to obtain a pixel density for the region. A feature vector representing the image can be generated from the plurality of pixel density values. It will be appreciated, however, that other features can be utilized for determining the orientation of an envelope in place of or in combination with the pixel density values in accordance with an aspect of the present invention.

The extracted feature vector is then provided to an orientation classification system 16. The orientation classification system 16 classifies each envelope image to determine an associated orientation for the envelope from a plurality of possible orientations.

The orientation classification system 16 can include one or more classifiers of various types including statistical classifiers, neural network classifiers, and self-organizing maps that have been designed or adapted to determine an appropriate orientation for the envelope according to the feature values generated by the feature extractor 14. In one implementation, the first and second images are classified separately with each image being classified either into an arbitrary “default” front-facing orientation class, a front-facing orientation class that represents a rotation of one hundred eighty degrees from the default class, and a back-facing class. By classifying the images in this manner, the two classifications serve to verify one another, as when one image is classified into one of the front-facing classes, the other image should be classified into the back-facing class. Further, if the confidence of the front or back classifications are low, the decision of the orientation may need further information (e.g., when both the front and back of the envelope contain text and indicia in the typical address and stamp locations).

In an exemplary implementation, the orientation classification system 16 can include an artificial neural network trained to assign an orientation class to a given image according to the numerical feature values provided by the feature extractor 14. A neural network is composed of a large number of highly interconnected processing elements that have weighted connections. It will be appreciated that these processing elements can be implemented in hardware or simulated in software. The organization and weights of the connections determine the output of the network, and are optimized via a training process to reduce error and generate the best output classification.

The values comprising the feature vector are provided to the inputs of the neural network, and a set of output values corresponding to the plurality of output classes is produced at the neural network output. Each of the set of output values represent the likelihood that the candidate image falls within the output class associated with the output value. The output class having the optimal output value is selected. What constitutes an optimal value will depend on the design of the neural network. In one example, the output class having the largest output value is selected.

The output of the orientation classification system 16 can then be provided to one or more downstream analysis systems 18 that provide further analysis of the envelope image, or alternate representations thereof, according to the output of the classification system 16 and at least one additional input representing the envelope. For example, the downstream analysis systems 18 can include an optical character recognition (OCR) system for translating at least a portion of the address on the envelope into machine readable data. To facilitate the function of the optical character recognition, the determined orientation can be provided to the OCR such that the text to be recognized can be rotated appropriately for analysis.

Similarly, the downstream analysis systems 18 can also include one or more specialized classifiers for detecting and identifying postal indicia from the envelope. Information about the orientation of the envelope can be used both for narrowing a search for the indicia, since indicia tend to be placed on specific regions of the envelope, as well as for ensuring that the indicia are in the proper orientation for a recognition process to be effective.

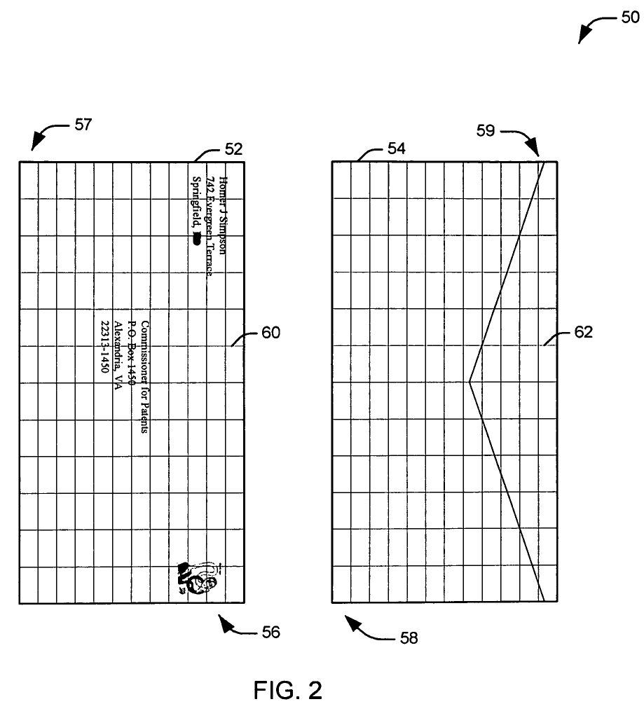

FIG. 2 provides a graphical representation 50 of an exemplary feature extraction process in accordance with an aspect of the present invention. The process begins when at least one envelope image 52 and 54 is provided to an indicia recognition system. In the illustrated example, a first binarized image 52, representing a first side of the envelope, and a second binarized image 54, representing a second side of the envelope, can be provided to the system. For example, the first image 52 can represent the output of a lead camera within the mail sorting system and the second image 54 can represent the output of a trail camera located on the opposite side of a conveyer belt that transports the envelope through the mail sorting system. It will be appreciated, however, that the orientation of the envelope on the conveyer belt is unknown at the time the images 52 and 54 are acquired. Accordingly, it is not known whether the output of the lead camera 52 or the output of the trail camera 54 represents the front of the envelope.

Further, the orientation of the front of the envelope is unknown. In accordance with an aspect of the present invention, the envelope can have one of four possible orientations as it travels down the conveyer belt. For example, the envelope can face upward in a first orientation or a second orientation that represents a one-hundred eighty degree rotation from the first orientation. Similarly, the envelope can face downward in a third orientation or a fourth orientation that represents a one-hundred eighty degree rotation from the third orientation.

The orientations available to the envelope can be understood most easily by considering the location of a stamp in each of the four orientations. In a first orientation, the envelope faces the lead camera, such that the first image 52 represents the front of the envelope. In this orientation, for the sake of example, it can be assumed that the stamp is located in a lower left corner 56 of the image 52. If the envelope is rotated, the only way to maintain the vertical alignment of the envelope is to rotate it a full one hundred eighty degrees, such that the stamp would be located in the upper right corner 57. Regardless of how the image is rotated, the stamp cannot be moved from one of these corners 56 and 57 while the envelope is in a vertical position unless the envelope is flipped to face downward or the stamp is in a non-standard position on the envelope. If the stamp is in a non-standard position, further analysis may need to be completed to determine what orientation the envelope is in. It will be appreciated, however, that postal standards govern the position of postal indicia on envelopes, and that situations where the indicia are in non-standard positions should be encountered infrequently.

Once the envelope is flipped, the stamp will appear on the image 54 associated with the trail camera. Assuming the envelope is flipped horizontally, the stamp will now appear in a lower left corner 58 of the trail image 54. A one hundred and eighty degree rotation of the envelope will place the stamp in an upper right corner 59 of the trail image. Again, regardless of how the envelope is rotated, the stamp must be present in one of these two locations if the stamp faces the trail camera and the envelope is maintained in a vertical position. Accordingly, it is only necessary to distinguish among four orientations during classification.

To this end, each envelope image is divided into a plurality of candidate regions. In the illustrated example, each envelope image 52 and 54 is divided into one hundred forty-four regions via respective twelve-by-twelve grids 60 and 62. In accordance with an aspect of the present invention, each of the plurality of regions is then analyzed to produce at least one feature value. In the illustrated example, the number of dark pixels in each region is counted and divided by an area of the region (i.e., the total number of pixels in region) to calculate a pixel density for the region. It will be appreciated that the pixel density across various regions of the envelope provides an indication of the orientation of the envelope. For example, the front of the envelope can be expected, on average, to have a higher pixel density than the back of the envelope. Similarly, one edge of the front of the envelope generally contains a return address and some form of postal indicia, so a higher pixel density can be expected along that edge. Thus, the pixel density values can be used to distinguish among the plurality of orientations in a classification task.

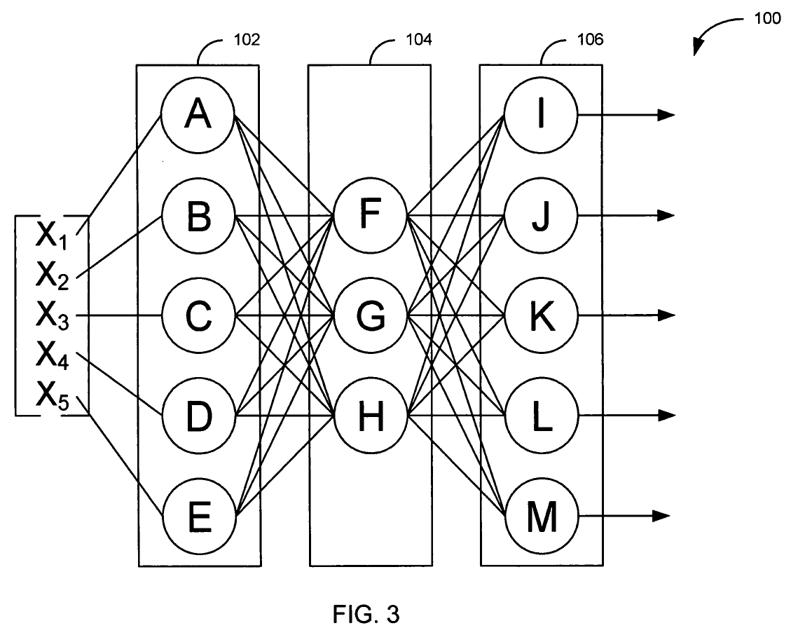

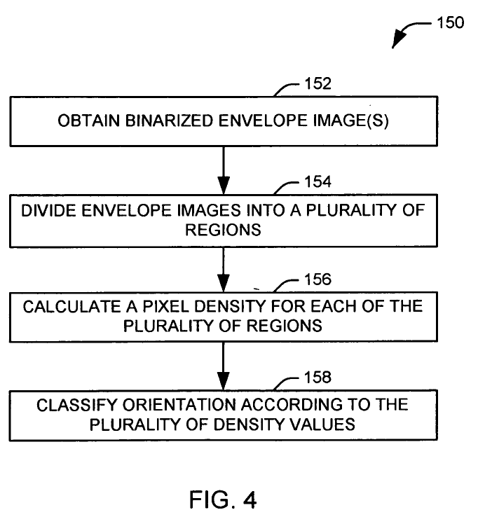

FIG. 3 illustrates an exemplary artificial neural network classifier 100. The illustrated neural network is a three-layer back-propagation neural network suitable for use in an elementary pattern classifier. It should be noted here, that the neural network illustrated in FIG. 4 is a simple example solely for the purposes of illustration. Any non-trivial application involving a neural network, including pattern classification, would require a network with many more nodes in each layer and/or additional hidden layers. It will further be appreciated that a neural network can be implemented in hardware as a series of interconnected hardware processors or emulated as part of a software program running on a data processing system.

In the illustrated example, an input layer 102 comprises five input nodes, A-E. A node, or neuron, is a processing unit of a neural network. A node may receive multiple inputs from prior layers which it processes according to an internal formula. The output of this processing may be provided to multiple other nodes in subsequent layers.

Each of the five input nodes A-E receives input signals with values relating to features of an input pattern. Preferably, a large number of input nodes will be used, receiving signal values derived from a variety of pattern features. Each input node sends a signal to each of three intermediate nodes F-H in a hidden layer 104. The value represented by each signal will be based upon the value of the signal received at the input node. It will be appreciated, of course, that in practice, a classification neural network can have a number of hidden layers, depending on the nature of the classification task.

Each connection between nodes of different layers is characterized by an individual weight. These weights are established during the training of the neural network. The value of the signal provided to the hidden layer 104 by the input nodes A-E is derived by multiplying the value of the original input signal at the input node by the weight of the connection between the input node and the intermediate node (e.g., G). Thus, each intermediate node F-H receives a signal from each of the input nodes A-E, but due to the individualized weight of each connection, each intermediate node receives a signal of different value from each input node. For example, assume that the input signal at node A is of a value of 5 and the weights of the connections between node A and nodes F-H are 0.6, 0.2, and 0.4 respectively. The signals passed from node A to the intermediate nodes F-H will have values of 3, 1, and 2.

Each intermediate node F-H sums the weighted input signals it receives. This input sum may include a constant bias input at each node. The sum of the inputs is provided into a transfer function within the node to compute an output. A number of transfer functions can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes F-H pass a signal with the computed output value to each of the nodes I-M of the output layer 106. An individual intermediate node (i.e. G) will send the same output signal to each of the output nodes I-M, but like the input values described above, the output signal value will be weighted differently at each individual connection. The weighted output signals from the intermediate nodes are summed to produce an output signal. Again, this sum may include a constant bias input.

Each output node represents an output class of the classifier. The value of the output signal produced at each output node is intended to represent the probability that a given input sample belongs to the associated class. In the exemplary system, the class with the highest associated probability is selected, so long as the probability exceeds a predetermined threshold value. The value represented by the output signal is retained as a confidence value of the classification.

In view of the foregoing structural and functional features described above, methodology in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates a methodology 150 for determining the orientation of an envelope in accordance with an aspect of the present invention. The process begins at step 152, where at least one image is taken of an envelope. In an exemplary implementation, respective lead and trail cameras on either side of a conveyer belt associated with a mail sorting system are used to take an image of each side of the envelope, such that a first image represents a front side of the envelope and second image represents a back side of the envelope. It will be appreciated, however, that at this step, it will not be known whether a given camera has imaged the front or the back of the envelope, merely that an image representing each side of the envelope has been acquired by the two cameras.

At step 154, each envelope image is divided into a plurality of regions. In an exemplary implementation, a twelve-by-twelve grid is applied over the envelope image to divide the image into one hundred forty-four regions. At step 56, a pixel density is calculated for each region. The number of dark pixels in each region is determined and divided by the total number of pixels comprising the region (i.e., the area of the region) to provide a density value for each region.

At step 158, each envelope image is classified as one of a plurality of output classes representing possible orientations of the envelope according to the calculated pixel densities for the plurality of regions comprising the image. For example, the output classes available for a given envelope image can include a first class, representing a default or “normal” orientation, a second class, representing a one hundred eighty degree rotation from the default orientation, and a third class, representing a “flipped” orientation in which the image represents the back of the envelope. It will be appreciated that where opposing lead and trail cameras are utilized to obtain the envelope images, one of the two images will be expected to represent the back of the envelope, such that the absence of a “flipped” result for at least one of the two images would be indicative of an unreliable classification result.

In one implementation, the density values can be provided as inputs to a neural network classifier that generates a plurality of output values, representing the plurality of output classes, a given output value indicating the likelihood that the candidate image belongs to the output class represented by the output value. An optimal output value can be selected by the system, and the output class represented by the selected output value can be provided to downstream analysis elements as an indicator of the orientation of the envelope.

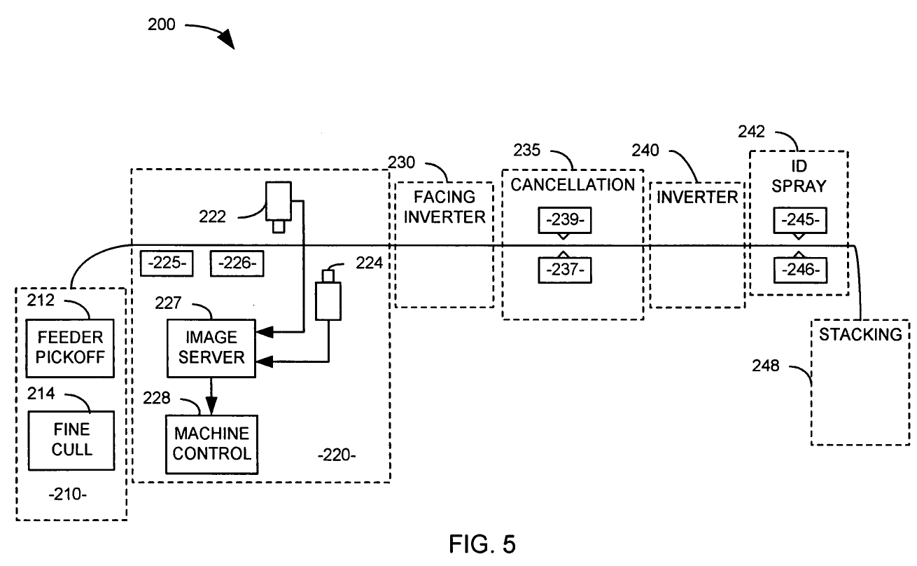

FIG. 5 illustrates an exemplary mail handling system 200 incorporating an orientation recognition system in accordance with an aspect of the present invention. The mail sorting system 200 comprises a singulation stage 210, an image lifting stage 220, a facing inversion stage 230, a cancellation stage 235, an inversion stage 240, an ID tag spraying stage 242, and a stacking stage 248. One or more conveyors (not shown) would move mailpieces from stage to stage in the system 200 (from left to right in FIG. 5) at a rate of approximately 3.6-4.0 meters per second.

A singulation stage 210 includes a feeder pickoff 212 and a fine cull 214. The feeder pickoff 212 would generally follow a mail stacker (not shown) and would attempt to feed one mailpiece at a time from the mail stacker to the fine cull 214, with a consistent gap between mailpieces. The fine cull 214 would remove mailpieces that were too tall, too long, or perhaps too stiff. When mailpieces left the fine cull 214, they would be in fed vertically (e.g., longest edge parallel to the direction of motion) to assume one of four possible orientations.

The the image lifting station 220 can comprise a pair of camera assemblies 222 and 224. As shown, the image lifting stage 220 is located between the singulation stage 210 and the facing inversion stage 230 of the system 200, but image lifting stage 220 may be incorporated into system 200 in any suitable location.

In operation, each of the camera assemblies 222 and 224 acquires both a low-resolution UV image and a high-resolution grayscale image of a respective one of the two faces of each passing mailpiece. Because the UV images are of the entire face of the mailpiece, rather than just the lower one inch edge, there is no need to invert the mailpiece when making a facing determination.

Each of the camera assemblies illustrated in FIG. 5 is constructed to acquire both a low-resolution UV image and a high-resolution grayscale image, and such assemblies may be used in embodiments of the invention. It should be appreciated, however, the invention is not limited in this respect. Components to capture a UV image and a grayscale image may be separately housed in alternative embodiments. It should be further appreciated that the invention is not limited to embodiments with two or more camera assemblies as shown. A single assembly could be constructed with an opening through which mailpieces may pass, allowing components in a single housing to form images of multiple sides of a mailpiece. Similarly, optical processing, such as through the use of mirrors, could allow a single camera assembly to capture images of multiple sides of a mailpiece.

Further, it should be appreciated that UV and grayscale are representative of the types of image information that may be acquired rather than a limitation on the invention. For example, a color image may be acquired. Consequently, any suitable imaging components may be included in the system 200.

As shown, the system 200 may further include an item presence detector 225, a belt encoder 226, an image server 227, and a machine control computer 228. The item presence detector 225 (exemplary implementations of an item presence detector can include a “photo eye” or a “light barrier”) may be located, for example, five inches upstream of the trail camera assembly 222, to indicate when a mailpiece is approaching. The belt encoder 226 may output pulses (or “ticks”) at a rate determined by the travel speed of the belt. For example, the belt encoder 226 may output two hundred and fifty six pulses per inch of belt travel. The combination of the item presence detector 225 and belt encoder 226 thus enables a relatively precise determination of the location of each passing mailpiece at any given time. Such location and timing information may be used, for example, to control the strobing of light sources in the camera assemblies 222 and 224 to ensure optimal performance independent of variations in belt speed.

Image information acquired with the camera assemblies 222 and 224 or other imaging components may be processed for control of the mail sorting system or for use in routing mailpieces passing through the system 200. Processing may be performed in any suitable way with one or more processors. In the illustrated embodiment, processing is performed by image server 227. It will be appreciated that, in one implementation, an orientation recognition system in accordance with an aspect of the present invention, could be implemented as a software program in the image server 227.

The image server 227 may receive image data from the camera assemblies 222 and 224, and process and analyze such data to extract certain information about the orientation of and various markings on each mailpiece. In some embodiments, for example, images may be analyzed using one or more neural network classifiers, various pattern analysis algorithms, rule based logic, or a combination thereof. Either or both of the grayscale images and the UV images may be so processed and analyzed, and the results of such analysis may be used by other components in the system 200, or perhaps by components outside the system, for sorting or any other purpose.

In the embodiment shown, information obtained from processing images is used for control of components in the system 200 by providing that information to a separate processor that controls the system. The information obtained from the images, however, may additionally or alternatively be used in any other suitable way for any of a number of other purposes. In the pictured embodiment, control for the system 200 is provided by a machine control computer 228. Though not expressly shown, the machine control computer 228 may be connected to any or all of the components in the system 200 that may output status information or receive control inputs. The machine control computer 228 may, for example, access information extracted by the image server 227, as well as information from other components in the system, and use such information to control the various system components based thereupon.

In the example shown, the camera assembly 222 and 224 is called the “lead” assembly because it is positioned so that, for mailpieces in an upright orientation, the indicia (in the upper right hand corner) is on the leading edge of the mailpiece with respect to its direction of travel. Likewise, the camera assembly 224 is called the “trail” assembly because it is positioned so that, for mailpieces in an upright orientation, the indicia is on the trailing edge of the mailpiece with respect to its direction of travel. Upright mailpieces themselves are also conventionally labeled as either “lead” or “trail” depending on whether their indicia is on the leading or trailing edge with respect to the direction of travel.

Following the last scan line of the lead camera assembly 222, the image server 227 may determine an orientation of “flip” or “no-flip” for the facing inverter 230. In particular, the inverter 230 is controlled so that that each mailpiece has its top edge down when it reaches the cancellation stage 235, thus enabling one of the cancellers 237 and 239 to spray a cancellation mark on any indicia properly affixed to a mailpiece by spraying only the bottom edge of the path (top edge of the mailpiece). The image server 227 may also make a facing decision that determines which canceller (lead 237 or trail 239) should be used to spray the cancellation mark. Other information recognized by the image server 227, such as information based indicia (IBI), may also be used, for example, to disable cancellation of IBI postage since IBI would otherwise be illegible downstream.

After cancellation, all mailpieces may be inverted by the inverter 242, thus placing each mailpiece in its upright orientation. Immediately thereafter, an ID tag may be sprayed at the ID spraying stage 244 using one of the ID tag sprayers 245 and 246 that is selected based on the facing decision made by the image server 227. In some embodiments, all mailpieces with a known orientation may be sprayed with an ID tag. In other embodiments, ID tag spraying may be limited to only those mailpieces without an existing ID tag (forward, return, foreign).

Following application of ID tags, the mailpieces may ride on extended belts for drying before being placed in output bins or otherwise routed for further processing at the stacking stage 248. Except for rejects, the output bins can be placed in pairs to separate lead mailpieces from trail mailpieces. It is desirable for the mailpieces in each output bin to face identically. The operator may thus rotate trays properly so as to orient lead and trail mailpieces the same way. The mail may be separated into four broad categories: (1) facing identification marks (FIM) used with a postal numeric encoding technique, (2) outgoing (destination is a different sectional center facility (SCF)), (3) local (destination is within this SCF), and (4) reject (detected double feeds, not possible to sort into other categories). The decision of outgoing vs. local, for example, may be based on the image analysis performed by the image server 227.

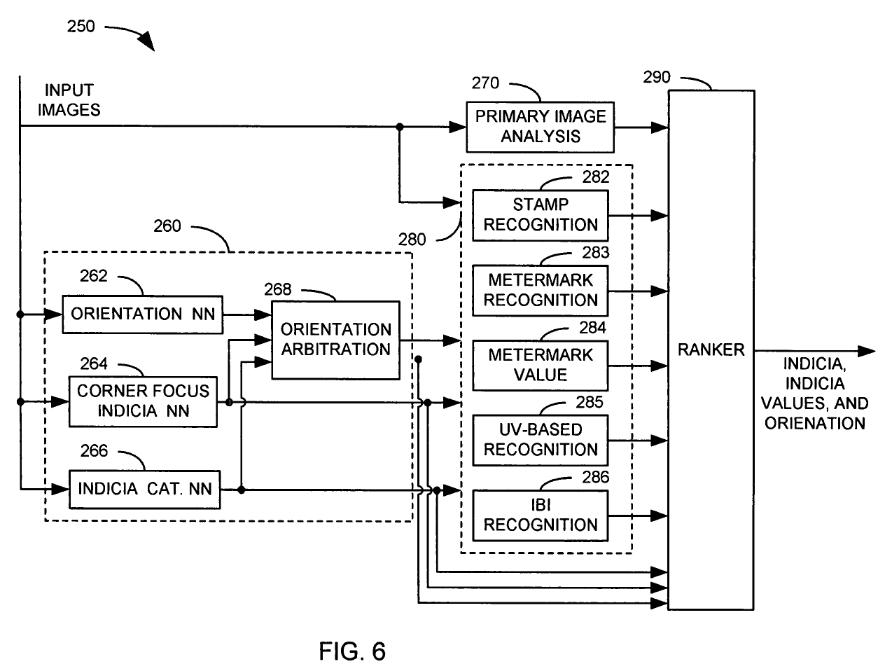

FIG. 6 illustrates an exemplary image processing system 250 for a mail handling system in accordance with an aspect of the present invention. The image processing system 250 can be roughly divided into two sequential stages. In a first stage, the orientation and facing of the envelope are determined as well as general information relating to the types of indicia located on the envelope. During the first processing stage, an orientation determination element 260 can be initiated to provide an initial determination of the orientation and facing of the envelope. In accordance with an aspect of the present invention, the first stage of image processing is designed to operate within less than one hundred eighty milliseconds.

One or more images can be provided to the orientation determination element 260 as part of the first processing stage. A plurality of neural network classifiers 262, 264, and 266 within the orientation determination element 260 are operative to analyze various aspects of the input images to determine an orientation and facing of the envelope. A first neural network classifier 262 comprises an orientation recognition system in accordance with an aspect of the present invention. A second neural network classifier 264 can comprise an indicia detection and recognition system that locates dense regions within the corners of an envelope and classifies the located dense regions into broad indicia categories. A third neural network classifier 266 can review information related to four different corners (two front and two back) to determine the presence and type, if present, of postal indicia within these regions.

The outputs of all three neural network classifiers 262, 264, and 266 are provided to an orientation arbitrator 268. The orientation arbitrator 268 determines an associated orientation and facing for the envelope according to the neural network outputs. In the illustrated implementation, the orientation arbitrator 268 is a neural network classifier that receives the outputs of the three neural network classifiers 262, 264, and 266 and classifies the envelope into one of four possible orientations.

Once an orientation for the envelope has been determined, a second stage of processing can begin. During the second stage of processing, one or more primary image analysis elements 270, various secondary analysis elements 280, and a ranking element 290 can initiate to provide more detailed information as to the contents of the envelope. In accordance with an aspect of the present invention, the second stage is operative to run in approximately two thousand two hundred milliseconds. It will be appreciated that during this time, processor resources can be shared among a plurality of envelopes.

The primary image analysis elements 270 are operative to determine one or more of indicia type, indicia value, and routing information for the envelope. Accordingly, a given primary image analysis element 270 can include a plurality segmentation routines and pattern recognition classifiers that are operative to recognize postal indicia, extract value information, isolate address data, and read the characters comprising at least a portion of the address. It will be appreciated that multiple primary analysis elements 270 can analyze the envelope content, with the results of the multiple analyses being arbitrated at the ranking element 290.

The secondary analysis elements 280 can include a plurality of classification algorithms that review specific aspects of the envelope. In the illustrated implementation, the plurality of classification algorithms can include a stamp recognition classifier 282 that identifies stamps on an envelope via template matching, a metermark recognition system 283, a metermark value recognition system 284 that locates and reads value information within metermarks, one or more classifiers 285 that analyze an ultraviolet florescence image, and a classifier 286 that identifies and reads information based indicia (ISI).

It will be appreciated that the secondary analysis elements 280 can be active or inactive for a given envelope according to the results at the second and third neural networks 264 and 266. For example, if it is determined with high confidence that the envelope contains only a stamp, the metermark recognition element 283, metermark value recognition element 284, and the IBI based recognition element 286 can remain inactive to conserve processor resources.

The outputs of the orientation determination element 260, the primary image analysis elements 270, and the secondary analysis elements 280 are provided to a ranking element 290 that determines a final output for the system 250. In the illustrated implementation, the ranking element 290 is a rule based arbitrator that determines at least the type, location, value, and identity of any indicia on the envelope according to a set of predetermined logical rules. These rules can be based on known error rates for the various analysis elements 260, 270, and 280. The output of the ranking element 290 can be used for decision making throughout the mail handling system.

FIG. 7 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus 306 by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. The remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A system for recognizing and identifying postal indicia on an envelope, comprising:
an image acquisition element that acquires a first image, representing a first side of the envelope, and a second image, representing a second side of the envelope;
a feature extractor that, for each of the first and second image, extracts a plurality of numerical feature values from each image as respective first and second feature vectors that represent the envelope; and
an orientation classification element that classifies the envelope into one of a plurality of output classes representing a plurality of possible orientations according to the first and second feature vectors.

2. The system of claim 1, wherein the orientation classification element comprises an artificial neural network classifier.

3. The system of claim 1, the feature extractor being operative to divide each of the first and second image into a plurality of regions and extract at least one numerical feature value from each of the plurality of regions associated with each image.

4. The system of claim 3, wherein the at least one numerical feature value comprises a ratio of dark pixels within the region to the total area of the region.

5. The system of claim 1, the image acquisition element being operative to acquire binarized images of the envelope, such that at least one of the first image and the second image is a binarized image.

6. The system of claim 1, the orientation classification element being operative to classify each of the first image and the second image into one of three output classes including a first class representing an arbitrary default orientation of the front of the envelope, a second class representing an orientation of the front of the envelope that is rotated one hundred eighty degrees from the default orientation, and a third class representing an orientation where the envelope image represents the back of the envelope.

7. The system of claim 6, the orientation classification element being operative to confirm that one image of the first and second images is classified as representing the back of the envelope and the other image of the first and second images is classified as representing the front of the envelope.

8. A mail handling system comprising:
the system of claim 1; and
at least one downstream analysis element that receives an associated output of the classification element and determines at least one characteristic of the envelope from the output of the classification element and a second input representing the envelope.

9. A computer program product, operative in a data processing system and stored on a computer readable medium, that determines the orientation of an envelope comprising:
an image acquisition element that obtains at least one binarized envelope image;
a feature extraction element that, for a given image of the envelope, divides the image into a plurality of regions, determines a value for each region representing the ratio of dark pixels within the region to the total area of the region, and combines the density values into a feature vector; and
a classification element that classifies the envelope image into one of a plurality of output classes representing various orientations according to the feature vector.

10. The computer program product of claim 9, wherein the classification element comprises an artificial neural network classifier.

11. The computer program product of claim 9, wherein the various orientations represented by the plurality of output classes comprise an arbitrary default orientation of the front of the envelope, an orientation of the front of the envelope that is rotated one hundred eighty degrees from the default orientation, and an orientation where the envelope image represents the back of the envelope.

12. The computer program product of claim 11, wherein acquires a first image, representing a first side of the envelope, and a second image, representing a second side of the envelope, and the classification element classifies each of the first and second image to one of the plurality of output classes.

13. The computer program product of claim 12, wherein the classification element is operative to confirm that one image of the first and second envelope images is classified as representing the back of the envelope and the other image of the first and second envelope images is classified as representing the front of the envelope.

14. The computer program product of claim 9, wherein the various orientations represented by the plurality of output classes comprise a first orientation of the front of the envelope, a second orientation of the front of the envelope that is rotated one hundred eighty degrees from the first orientation, a third orientation where the envelope is flipped, such that the envelope image represents the back of the envelope, and a fourth orientation where the envelope is rotated one hundred eighty degrees from the third orientation.

15. A method for determining an associated orientation of an envelope in real-time, comprising:
acquiring at least one envelope image;
dividing each envelope image into a plurality of regions;
extracting at least one numerical feature value from each of the plurality of regions associated with a given envelope image;
combining the extracted numerical feature values from each of the plurality of regions associated with a given envelope image into a single feature vector representing the envelope image; and
determining from the feature vector representing each envelope image a set of three output values, a first output value representing the likelihood that the envelope image represents an arbitrary default orientation of the front of the envelope, a second output value representing the likelihood that the envelope image represents an orientation of the front of the envelope that is rotated one hundred eighty degrees from the default orientation, and a third output value representing the likelihood that the envelope image represents the back of the envelope.

16. The method of claim 15, further comprising providing at least one set of output values associated with the at least one envelope image to at least one downstream analysis element that determines at least one characteristic of the envelope according to the set of output values and at least one additional input representing the envelope.

17. The method of claim 15, wherein extracting at least one numerical feature value from each of the plurality of regions comprises determining a pixel density for each of the plurality of regions as the ratio of the number of dark pixels in a given region to its area in pixels.

18. The method of claim 15, wherein determining from the feature vector representing each envelope image a set of three output values comprises classifying the feature vector as a series of inputs to an artificial neural network classifier.

19. The method of claim 15, wherein acquiring at least one envelope image comprises acquiring a binarized image of the envelope.

20. The method of claim 15, wherein acquiring at least one envelope image comprises acquiring a first envelope image, representing a first side of the envelope and acquiring a second envelope image, representing a second side of the envelope, the method further comprising the step of comparing a first set of output values associated with the first image to a second set of output values associated with the second image to confirm that one image of the first and second envelope images is classified as representing the back of the envelope and the other image of the first and second envelope images is classified as representing the front of the envelope.
